(19) United States
(12) Patent Application Publication
(10) Pub. No.: US 2014/0299820 A1
(43) Pub. Date: Oct. 9, 2014

(54) GRAPHENE NANOPARTICLES AS CONDUCTIVE FILLER FOR RESISTOR MATERIALS AND A METHOD OF PREPARATION

(71) Applicants: Michael Harandek, Oak Park, MI (US); Hiroyuki Fukushima, Okemos, MI (US); Jeffri Narendra, Okemos, MI (US)

(72) Inventors: Michael Harandek, Oak Park, MI (US); Hiroyuki Fukushima, Okemos, MI (US); Jeffri Narendra, Okemos, MI (US)

(21) Appl. No.: 13/858,149

(22) Filed: Apr. 8, 2013

(51) Int. Cl. C04B 35/10

(52) U.S. Cl. CPC C04B 35/10
USPC 252/508; 162/138

(57) ABSTRACT

A composition of matter comprising graphene nano platelets, one or more ceramic fillers and, one or more high temperature fibers. In another embodiment, there is a flat sheet article comprising a calendered combination of graphene nano platelets, one or more ceramic fillers and, one or more high temperature fibers. A process for preparing an article containing graphene nano platelets, one or more ceramic fillers and, one or more high temperature fibers.

### BACKGROUND OF THE INVENTION

The use of graphene for conduction in various materials using ceramic matrices is known however, nowhere in the prior art is there shown, disclosed or used, flexible high temperature fibers in conjunction with the graphene nano platelets and ceramic fillers for these types of materials.

Typically, the prior art materials are thin films or layers and are prepared by providing graphene oxide, silica matrices of some type, and are produced from suspensions of graphene oxide and a silica precursor or silica to form a suspension to form a sol. Thereafter, the sol is deposited on a substrate as a thin film or layer and reduced to conductive graphene oxide/graphene containing sheets. Thereafter, the thin film or layer is thermally consolidated to form a silica matrix in which the graphene oxide is dispersed. One such material known to the inventors herein is U.S. Patent publication 2010/0323178, that published on Dec. 23, 2010 to Ruoff, et al.

### THE INVENTION

What is disclosed and claimed herein is a composition of matter comprising graphene nano platelets, one or more ceramic fillers and, one or more high temperature fibers. In another embodiment, this invention comprises a flat sheet article comprising a calendered combination of graphene nano platelets, one or more ceramic fillers and, one or more high temperature fibers, wherein the graphene is present in the range of 10 weight percent to 80 weight percent, one or more ceramic fillers are present in a range of 5 weight percent to 80 weight percent, and one or more high temperature fibers are present in the range of 5 weight percent to 60 weight percent.

In addition, there is a second embodiment which is a process for preparing the article containing the graphene nano particle, one or more ceramic fillers and, one or more high temperature fibers. The process comprises providing a predetermined amount of graphene nano platelets, one or more ceramic fillers, and one or more high temperature fibers and blending them in aqueous solution for a predetermined period of time. Graphene nano platelets and the high temperature fibers must be properly wetted out to prevent agglomeration and/or flocculation. Adding a dispersant agent such as surfactants or pH adjuster combine with a high shear mixer or an ultrasonic homogenizer may be useful in dispersing the graphene nano platelets and the high temperature fiber.

Thereafter, the wetted out graphene nano platelets are added to a blender with a predetermined amount of water to form a slurry. Thereafter, one or more ceramic fillers are added and one or more high temperature fiber in a predetermined ratio for a predetermined time. Refractory binders may be added to increase the material strength. Thereafter, the slurry is transferred to an agitation tank and there is added a predetermined amount of water to a predetermined consistency for a wet laid nonwoven process.

Next, the slurry is poured into a forming box which consists of a headbox, a drain, and a forming wire. The slurry in the headbox is stirred using a stirring apparatus for a predetermined period of time and then the slurry is drained using a vacuum that is applied to the box to form a wet web on the forming wire. The forming box is opened and a forming wire is placed on the wet formed web.

Thereafter, the formed web is placed in a drying apparatus such as a heated drum roll or a conveyor oven for a predetermined period of time and at a predetermined temperature. The sheet is thereafter dried.

The dried web, which can also be referred to as a sheet, is calendered using rollers at a predetermined nip pressure for a predetermined period of time. The sheets maybe be supported by supporting plates/sheets/films made of nylon, polypropylene, polyethylene, polyethylene terephthalate, polystyrene, polycarbonate, polyvinyl chloride, acrylonitrile-butadiene-styrene, polyoxymethylene, polytetrafluoroethylene, polyvinylidene fluoride, polyfluoroalkoxy, polyphenylene sulfide, polysulfone, polyether ether ketone, acrylic polymer, polyamide, polyamide-imide, iron, steel, stainless steel, aluminum, aluminum alloys, copper, brass, bronze, nickel, nickel alloys, titanium, titanium alloys, tin, tin alloys, tungsten, tungsten alloys, zinc, zinc alloys, or any combination of these materials during the calendaring process.

### BRIEF DESCRIPTION OF THE DRAWINGS

FIG. 1 is an infrared image of material of this invention with 9.1 Watts of power applied.

FIG. 2 is an infrared image of material of this invention with 15 Watts of power applied.

### DETAILED DESCRIPTION OF THE INVENTION

This invention deals with graphene nano platelets as conductive fillers for resistor materials in which there is also present one or more ceramic fillers and one or more high temperature fibers, all of which are combined in a dry, flat sheet structure to provide resistor materials. Such resistive materials are very useful for resistive heating applications such as defrosting automotive roof heating, airplane wings, home appliances, military or recreational heaters with low power sources, and the like.

Pure graphene nano platelets can be pressed or calendered to form a flexible highly conducting paper. However, sometime, the conductivity is too high for resistive heating applications, which are the most efficient at high resistivity. Thus, mixing graphene nano particles with other materials that are non-conducting such as ceramic fillers can lower the overall conductivity. The highest electrical resistivity as a resistor is achieved when the graphene nano particle volume fraction content is slightly higher than the percolation threshold. The “percolation threshold” is the minimum material necessary to have a complete continuous network of the material. If there is not enough electrically conductive material to connect continuously, then there is little or no conductivity and the material can be considered as a dielectric or insulator, which do not work as resistive heaters. Mixing only the graphene nano particle with ceramic filler would make the composites too heavy and brittle. Thus, lighter, high temperature fibers are mixed in. This helps in reducing the weight while maintaining the strength of the paper. In addition, the graphene nano platelets can be tailored as needed.

The amount of graphene useful in the inventive composition is in the range of 10 weight percent to 80 weight percent. Such a graphene can be for example, xGnP graphene commercially available from XG Sciences, Lansing, Mich. USA.

The ceramic fillers useful in this invention are such materials as aluminum oxide, alumina silicate, mica boron nitride, calcium silicate, silica, silicon nitride, silicon carbide, titanium carbide, tungsten carbide, and zirconia. It should be noted that mixtures of ceramic fillers can be used in this invention.

The high temperature fibers useful in this invention are such materials as aramid fibers, poly-phenylene benzobisoxazole, carbon fibers, carbon nanotube, carbon nanofibers, graphene ribbons, polyphenylene sulfide fibers, melamine fibers, polybenzimidazole fiber, polyimide fiber and Lastan, a carbon precursor. It should be noted that mixtures of high temperature fibers can be used in this invention.

The process of this invention can be found illustrated in example 1, infra.

### EXAMPLE 1

### Producing Material with High Electrical Resistivity

An AMC Formax hand sheet mold was used to form the materials, an infrared oven was used to dry the materials, and the calendaring was carried out with two hard rollers. xGnP (12 weight %), aramid fiber (9.2 weight %), and 78.8 wt % of silica/alumina fiber having approximately a 50:50 ratio of silica to alumina were weighed out (the silica/alumina fibers had an average diameter of 1.5 to 2.5 microns and a density of 2.73 gm/cc). The aramid fiber was wetted out using an ultrasonic homogenizer. The silica/alumina fiber mixture and the aramid fibers were placed inside a Fleetwood blender and water was added to achieve the final solid consistency of 1%. The fibers were blended using a pulping process for about 30 minutes. Typically, this step varies according to the composition and consistency of the fiber/water ratio.

The graphene nano platelets, wetted with water, were added into the blender and blended for approximately 15 minute to uniformly mix the graphene nano platelets and the pulp slurry of the fibers. The slurry was then added into an agitating tank containing water in an amount to provide the desired consistency, and agitated.

The slurry was poured into the forming box until it reached a predetermined volume. The slurry was gently stirred using the headbox agitator for 5 seconds and the agitator was removed from the headbox. Thereafter the slurry was drained with the help of a vacuum system. The lid was opened and a second forming wire was placed on top of the formed wet web, followed by a felting paper. A roller was used to press the composite to further drain the water and to provide a more uniform surface.

The formed web was transferred to an XWAV infrared oven conveyor and slowly moved through the oven and in this particular piece of equipment, once the composite moved through the oven, it was flipped over and moved through the oven a second time to provide uncompressed sheets. The sheets were separated from the forming wires. Additional sheets were prepared in the same manner from the slurry. The sheets at this point were allowed to sit overnight to further dry.

During the calendaring process, the sheets were then handled in the following manner. The sheets were trimmed down to get 11″×11″ sheets using a paper cutter. Then a forming composite was assembled by arranging layers in the order of nylon sheet/steel sheet/formed sheet/steel plate/formed sheet/steel plate/formed sheet/steel plate/nylon sheet. Then the forming composite was calendered in a machine. Thereafter, the forming composite was disassembled and the formed sheets were retrieved. After the calendaring process, the sheets were trimmed into 11″ by 11″ sizes with a paper cutter.

### EXAMPLE 2

A sample of a material of this invention was prepared using ceramic filler, xGnP obtained from XG Sciences, and Kevlar fiber. The composition of the pulp mixture by weight was 81.5% ceramic fiber, 103% xGnP, and 8% Kevlar fiber. This mix ratio translates to graphene loading of 15% by volume. The sheet samples were made by following the same procedure used in Example 1. This composition increased resistivity of the formed sheet as well as the ability to withstand high temperatures.

By using a low amount of graphene nano platelets, the formed sheet had a much higher resistance. This allowed for a sample double the width to achieve higher temperatures at lower watts.

The ceramic filler and the Kevlar fibers are able to withstand much higher temperatures, compared to a graphene sheet without such fillers and fibers, making them better suited for high heat applications.

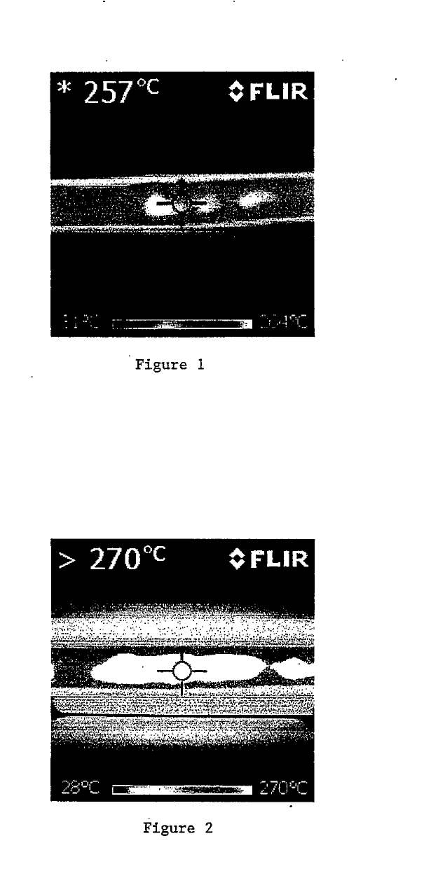

The performance of the resistive sheets as a heating element can be observed in FIGS. 1 and 2. The bulk resistance of the sample used was 127 ω and the sample was 9.5 cm×1 cm. FIG. 1 shows the temperature of the sample at 257° C. with 9.1 Watts applied using 34 V. FIG. 2 shows that the temperature of nearly the entire sample exceeds the 270° C. (maximum range of the measurement instrument) when 15 Watts are applied using 44 V.

What is claimed is:

1. A composition of matter comprising:
A. graphene nano platelets;
B. one or more ceramic fillers and,
C. one or more high temperature fibers.

2. A flat sheet article comprising a calendered combination of
A. graphene nano platelets;
B. one or more ceramic fillers and,
C. one or more high temperature fibers,
wherein said graphene nano platelets are present in the range of 10 weight percent to 80 weight percent, said one or more ceramic fillers are present in a range of 5 weight percent to 80 weight percent, and said one or more high temperature fibers are present in the range of 5 weight percent to 60 weight percent.

3. A flat sheet article as claimed in claim 2 wherein said ceramic filler is selected from the group consisting of:
i. aluminum oxide,
ii. alumina silicate,
iii. mica,
iv. boron nitride,
v. calcium silicate,
vi. silica,
vii. silicon nitride,
viii. silicon carbide,
ix. titanium carbide, x. tungsten carbide,
xi. zirconia, and,
xii. any combination of i. to xi.

4. A flat sheet article as claimed in claim 2 wherein said high temperature fiber is selected from the group consisting of:
a. aramid fibers,
b. poly-phenylene benzobisoxazole,
c. carbon fibers,
d. carbon nanotubes,
e. carbon nanofibers,
f. graphene ribbons,
g. polyphenylene sulfide fibers,
h. melamine fibers,
i. polybenzimidazole fibers,
j. polyimide fibers,
k. carbon precursor fibers, and,
l. any combination of a. to k.

5. A process for preparing the article as claimed in claim 2, said process comprising:
a. provide predetermined amounts of graphene nano platelets, one or more ceramic fillers, and one or more high temperature fibers;
b. wetting out in water, said one or more high temperature fibers;
c. blend one or more said ceramic fillers and said one or more high temperature fibers in a blender at a predetermined ratio for a predetermined time;
d. add said graphene nano platelets into said blender and blend for a predetermined period of time to provide a slurry;
e. add said slurry to an agitator tank and add a predetermined amount of water and agitate for a predetermined period of time;
f. provide a paper forming apparatus;
g. add said slurry from e. into said paper forming apparatus;
h. apply a vacuum to said paper forming apparatus to form a wet web;
i. complete paper forming in said paper forming apparatus;
j. dry said formed sheet;
k. support said formed sheets on a support to form a forming composite;
I. calendar said forming composite for a predetermined period of time;
m. separate said forming composite to provide a dry, flat sheet article.

6. A process as claimed in claim 3 wherein said paper forming apparatus is a forming box.
